(19) United States
(12) Patent Application Publication
(10) Pub. No.: US 2025/0253434 A1
(43) Pub. Date: Aug. 7, 2025

(54) BATTERY PACK

(71) Applicant: INZICONTROLS CO., LTD., Siheung-si (KR)

(72) Inventors: Jung Min KIM, Siheung-si (KR); Soo Gil KIM, Siheung-si (KR); Hyoung Min CHOI, Siheung-si (KR); Seung Yong YOO, Siheung-si (KR); Min Joo KANG, Siheung-si (KR)

(73) Assignee: INZICONTROLS CO., LTD., Siheung-si (KR)

(21) Appl. No.: 19/086,208

(22) Filed: Mar. 21, 2025

Related U.S. Application Data
(63) Continuation of application No. PCT/KR2023/014481, filed on Sep. 22, 2023.

(30) Foreign Application Priority Data
Sep. 22, 2022 (KR) 10-2022-0120293
Dec. 16, 2022 (KR) 10-2022-0177031

(51) Int. Cl. H01M 10/6556; H01M 10/613; H01M 10/6569; H01M 10/659; H01M 50/204; H01M 50/289; H01M 50/627

(52) U.S. Cl. CPC H01M 10/6556; H01M 10/613; H01M 10/6569; H01M 10/659; H01M 50/289; H01M 50/627; H01M 50/204

(57) ABSTRACT

A battery pack includes: a battery pack in which a plurality of battery modules are arranged; an upper heat sink covering the upper surface of the battery pack and having a plurality of upper cooling flow passages through which a cooling fluid may flow to cool the battery modules; and a lower heat sink covering the lower surface of the battery pack and having a plurality of lower cooling flow passages through which a cooling fluid may flow to cool the battery modules.

### CROSS REFERENCE TO RELATED APPLICATIONS

This application is a Bypass Continuation of International Application No. PCT/KR2023/014481 filed Sep. 22, 2023, claiming priority based on Korean Patent Application No. 10-2022-0120293 filed Sep. 22, 2022 and Korean Patent Application No. 10-2022-0177031 filed Dec. 16, 2022.

### TECHNICAL FIELD

The present invention relates to a battery pack capable of improving a vehicle cooling system.

### BACKGROUND ART

Generally, batteries are widely used in electrical devices that cannot be connected via wired connections, such as portable electronic devices, mobile communication terminals, and electric vehicles. As a result, research and development on batteries have become more active in line with the expansion trend of the battery market. However, incidents of battery fires or explosions still frequently occur.

Such battery fires or explosions may be caused by various factors, including damage due to impact, design errors, short circuits, and harsh usage environments, making it still difficult to completely prevent them.

Meanwhile, the adoption of electric vehicles has been rapidly expanding in recent years. Conventional electric vehicles use high-capacity battery modules or battery packs. For such electric vehicle battery modules or battery packs, increasing performance and capacity is important, but it is also crucial to prevent human injury and property damage caused by fires and explosions. Accordingly, recent research and development efforts have been actively conducted to develop battery modules or battery packs that possess high capacity, high efficiency, and high safety.

### DISCLOSURE

### Technical Problem

The objective of the present invention is to improve assembly efficiency and productivity by configuring a battery cooling device on a battery pack unit basis.

Additionally, the present invention aims to provide a battery pack that enhances the cooling performance of a battery module through a structure applying a heat-absorbing material to the battery module, while also reducing the volume and weight of the vehicle cooling system layout.

### Technical Solution

According to one embodiment of the present invention, a battery pack comprises: a battery pack in which a plurality of battery modules are arranged, an upper heat sink covering an upper surface of the battery pack and having a plurality of upper cooling flow passage units formed therein to allow a cooling fluid to flow therethrough to cool the battery modules, and a lower heat sink covering a lower surface of the battery pack and having a plurality of lower cooling flow passage units formed therein to allow a cooling fluid to flow therethrough to cool the battery modules.

In one embodiment of the present invention, the upper cooling flow passage unit or the lower cooling flow passage unit includes a U-shaped flow passage and is configured to have an identical shape, wherein the flow passage units are symmetrically formed to face each other based on a reference line.

In one embodiment of the present invention, the adjacent upper cooling flow passage unit or lower cooling flow passage unit, based on the flow direction of the cooling fluid, is connected by a connection flow passage.

In one embodiment of the present invention, the connection flow passage is arranged in a straight shape along the reference line direction.

In one embodiment of the present invention, each of the upper cooling flow passage unit or lower cooling flow passage unit is configured to cool at least one of the plurality of battery modules.

In one embodiment of the present invention, the upper cooling flow passage unit or lower cooling flow passage unit includes a first curved portion through which the cooling fluid flows and a second curved portion formed between the first curved portions.

In one embodiment of the present invention, the battery module includes a fixing portion for securing a battery cell, and the second curved portion has a shape into which the fixing portion may be inserted.

In one embodiment of the present invention, the fixing portion is a strap in the form of a bar.

In one embodiment of the present invention, the lower cooling flow passage unit has a thickness greater than that of the upper cooling flow passage unit.

In one embodiment of the present invention, the upper cooling flow passage unit or lower cooling flow passage unit is connected to a single inlet and is also connected to a single outlet.

In one embodiment of the present invention, the inlet and outlet connected to the upper cooling flow passage unit are respectively connected to an upper inlet port and an upper outlet port, and the inlet and outlet connected to the lower cooling flow passage unit are respectively connected to a lower inlet port and a lower outlet port.

In one embodiment of the present invention, the upper inlet port and the lower inlet port are connected to form a single inlet port, and the upper outlet port and the lower outlet port are connected to form a single outlet port.

In one embodiment of the present invention, a pad-type gap filler is positioned between an upper surface of the battery module and the upper heat sink.

In one embodiment of the present invention, the pad-type gap filler is positioned only in a specific region of the upper surface of the battery module.

In one embodiment of the present invention, a gel-type gap filler is positioned in a region of the upper surface of the battery module where the pad-type gap filler is not positioned.

In one embodiment of the present invention, a gel-type gap filler is positioned between each bottom surface of the plurality of battery modules and the lower heat sink.

Meanwhile, a battery pack according to the present invention comprises: a battery pack in which a plurality of battery modules are arranged, and a heat sink covering an upper surface or a lower surface of the battery pack and having a plurality of cooling flow passage units formed therein to cool the battery modules, wherein the cooling flow passage unit includes a first curved portion through which a cooling fluid flows and a second curved portion formed between the first curved portions.

In one embodiment of the present invention, the first curved portion has a first width, and the second curved portion has a second width, wherein the first width is greater than the second width.

In one embodiment of the present invention, the first curved portion has a first height, and the second curved portion has a second height, wherein the first height is greater than the second height.

According to one embodiment of the present invention, a battery pack comprises: a battery module assembly, a flow passage unit coupled to the battery module assembly and configured to allow a cooling fluid to flow therethrough, a plurality of heat sinks, each having an accommodation portion, which is a space between partition walls formed on a side surface of the flow passage unit, wherein a heat-absorbing material is accommodated in the accommodation portion, and pipes connecting the respective heat sinks, wherein each of the heat sinks comprises: a first plate having a groove-shaped flow passage unit formed on one surface thereof, the groove being open at an upper side, and having the accommodation portion formed on the other surface thereof, the groove being open at a lower side, a second plate coupled to cover the one surface of the first plate, and a third plate coupled to cover the other surface of the first plate.

In one embodiment of the present invention, the heat sinks are coupled to a bottom surface of the battery module assembly.

In one embodiment of the present invention, the flow passage unit comprises a linear flow passage unit extending in a straight direction and a curved flow passage unit configured to change a flow direction of the linear flow passage unit.

In one embodiment of the present invention, the flow passage unit is configured such that the linear flow passage unit and the curved flow passage unit are symmetrically formed on both sides of the first plate based on a center thereof.

In one embodiment of the present invention, the partition walls have an inclined shape with respect to a bottom surface of the first plate or have a curved shape.

In one embodiment of the present invention, an inlet hole through which the cooling fluid flows into and an outlet hole through which the cooling fluid is discharged are formed in the outermost linear flow passage unit of the first plate.

In one embodiment of the present invention, the third plate has port holes formed at positions corresponding to the inlet hole and the outlet hole.

In one embodiment of the present invention, the heat sink includes an inlet port connected to the inlet hole and an outlet port connected to the outlet hole.

In one embodiment of the present invention, the third plate is coupled in correspondence with a region of the other surface of the first plate where the heat-absorbing material is accommodated.

In one embodiment of the present invention, the third plate includes an injection port through which the heat-absorbing material is injected into the accommodation portion.

In one embodiment of the present invention, the injection port is formed in a central region of the third plate.

In one embodiment of the present invention, the battery pack includes a suction port configured to intake air from the accommodation portion.

In one embodiment of the present invention, the suction port is formed in a corner region of the third plate.

In one embodiment of the present invention, the heat-absorbing material is accommodated in the accommodation portion in a solid or liquid state and is formed to correspond to the shape of the side surfaces of the partition walls.

In one embodiment of the present invention, the third plate is configured as a cover made of a film material and is attached to the first plate.

In one embodiment of the present invention, the third plate is formed to have a smaller area than the first plate.

According to one embodiment of the present invention, a battery pack comprises: a battery module assembly, a plurality of heat sinks disposed in correspondence with the battery module assembly, wherein at least one of the heat sinks comprises: a first plate having a groove shape formed on one surface thereof and a groove shape formed on the other surface thereof, a second plate covering the one surface of the first plate, a third plate covering the other surface of the first plate, and a flow passage unit formed in the groove shape on the one surface of the first plate, the flow passage unit being configured to allow a cooling fluid to flow therethrough, wherein an accommodation portion is disposed between sections of the flow passage unit, and a heat-absorbing material is accommodated in the accommodation portion, wherein the flow passage units of the respective heat sinks are connected through pipes, and wherein a protruding surface of the groove shape formed on the one surface of the first plate is lower than an end surface of the second plate.

In one embodiment of the present invention, the at least one heat sink is coupled to a bottom surface of the battery module assembly.

In one embodiment of the present invention, the flow passage unit comprises a linear flow passage unit formed in a longitudinal direction of the at least one heat sink and a curved flow passage unit configured to change a flow direction of the linear flow passage unit.

In one embodiment of the present invention, the flow passage unit is configured such that the linear flow passage unit and the curved flow passage unit are symmetrically formed on both sides of the first plate based on a center thereof.

In one embodiment of the present invention, partition walls are formed on side surfaces of the flow passage unit, wherein the partition walls are formed between the groove shape formed on the one surface of the first plate and the groove shape formed on the other surface of the first plate, and wherein the partition walls have an inclined shape with respect to a bottom surface of the first plate or have a curved shape.

In one embodiment of the present invention, the linear flow passage unit comprises a first linear flow passage unit and a second linear flow passage unit, wherein an inlet hole through which the cooling fluid flows into is formed in the first linear flow passage unit, and an outlet hole through which the cooling fluid is discharged is formed in the second linear flow passage unit.

In one embodiment of the present invention, the third plate has port holes formed at positions corresponding to the inlet hole and the outlet hole.

In one embodiment of the present invention, the third plate is formed to have a smaller area than the first plate.

In one embodiment of the present invention, the third plate is configured to cover a region of the other surface of the first plate where the heat-absorbing material is accommodated.

In one embodiment of the present invention, the third plate includes a plurality of ports.

In one embodiment of the present invention, the ports include an injection port and a suction port, wherein the injection port is formed in a central region of the third plate, and the suction port is formed in a corner region of the third plate.

In one embodiment of the present invention, the heat-absorbing material is formed to correspond to the shape of the side surfaces of the partition walls.

In one embodiment of the present invention, a width of the flow passage unit is greater than a width of the accommodation portion.

### Advantageous Effects

According to the present invention, since the heat sink is configured on a battery pack unit basis, assembly efficiency is improved during battery pack manufacturing, enabling mass production.

In addition, according to the present invention, since heat sinks are mounted on both the upper and lower portions of the battery pack, heat generated from the battery cells is transferred to both the upper and lower sides, thereby improving cooling efficiency.

Furthermore, according to the present invention, the structure of the upper and lower heat sinks is simple, and the number of inlet and outlet ports for the cooling fluid is reduced, thereby lowering the risk of leakage due to damage to the cooling fluid pipes.

Moreover, according to the present invention, by using a pad-type gap filler between the upper heat sink and the battery module, the application area of the gel-type gap filler may be reduced, thereby saving battery pack weight and assembly time.

Meanwhile, according to the present invention, excellent battery cooling performance may be achieved through a dual cooling system that utilizes both cooling fluid and a heat-absorbing material.

Additionally, according to the present invention, since the heat-absorbing material is formed in regions other than the area where the flow passage unit is formed in the heat sink, battery cells or battery modules generating heat may be effectively cooled through the dual cooling system without increasing the capacity of the radiator or pump.

### DESCRIPTION OF DRAWINGS

FIG. 1 is a perspective view illustrating a battery pack according to an embodiment of the present invention.

FIG. 2 is an exploded perspective view of the battery pack shown in FIG. 1.

FIG. 3 is a top view of a battery module assembly according to the present invention.

FIG. 4 is a cross-sectional view taken along line A1-A1′ of FIG. 1.

FIG. 5 is a diagram illustrating an upper cooling flow passage unit formed in an upper heat sink according to an embodiment of the present invention.

FIG. 6 is a diagram illustrating a state in which a pad-type gap filler is arranged on the upper surface of the battery module assembly according to an embodiment of the present invention.

FIG. 7 is an enlarged view of portion Y shown in FIG. 6.

FIG. 8 is a cross-sectional view taken along line B1-B1′ of FIG. 1.

FIG. 9 is a diagram illustrating the state of an inlet port and an outlet port according to an embodiment of the present invention.

FIG. 10 is a diagram illustrating the state of an inlet port and an outlet port according to another embodiment of the present invention.

FIG. 11 is a perspective view illustrating a battery pack according to an embodiment of the present invention.

FIG. 12 is an exploded perspective view of a battery pack according to an embodiment of the present invention.

FIG. 13 is a diagram illustrating a state in which a heat sink is mounted on a battery module assembly according to an embodiment of the present invention.

FIG. 14 is a diagram illustrating the upper and lower surfaces of a heat sink according to an embodiment of the present invention.

FIG. 15 is an exploded perspective view of a heat sink according to an embodiment of the present invention.

FIG. 16 is a diagram illustrating the lower surface of a first plate according to an embodiment of the present invention.

FIG. 17 is a cross-sectional view taken along line B2-B2′ of FIG. 16.

FIG. 18 is a cross-sectional view taken along line C2-C2′ of FIG. 16.

FIGS. 19A and 19B are diagrams illustrating a heat sink according to another embodiment of the present invention.

FIG. 20 is a bottom view illustrating the lower surface of a battery pack according to an embodiment of the present invention.

FIG. 21 is a cross-sectional view taken along line A2-A2′ of FIG. 13.

FIG. 22 is an enlarged view of portion X shown in FIG. 21.

FIG. 23 is a diagram illustrating an assembly process of a heat sink according to an embodiment of the present invention.

FIG. 24 is a diagram illustrating an assembly process of a heat sink according to another embodiment of the present invention.

### BEST MODE

The following is a detailed description of a battery pack according to a preferred embodiment with reference to the accompanying drawings. In this description, the same reference numerals are used for the same components, and redundant explanations, as well as detailed descriptions of well-known functions and structures that may unnecessarily obscure the gist of the invention, are omitted. The embodiments of the invention are provided to enable those skilled in the art to fully understand the present invention. Accordingly, the shapes and sizes of elements in the drawings may be exaggerated for clarity of explanation.

### First Embodiment

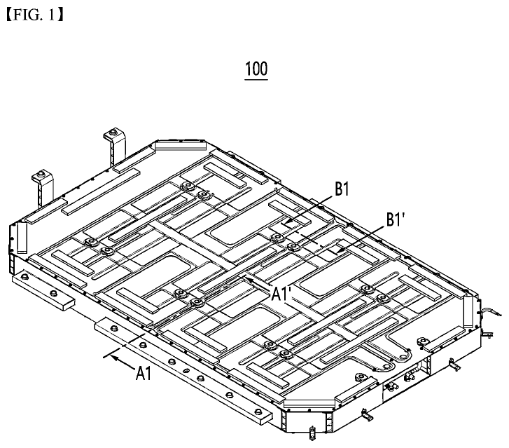

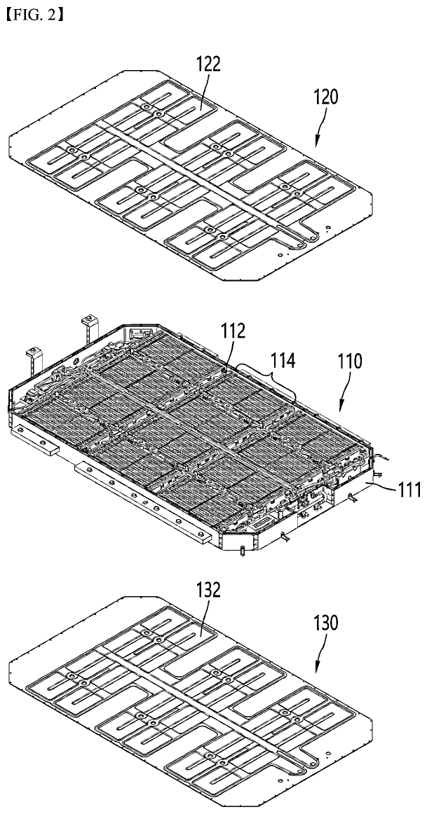

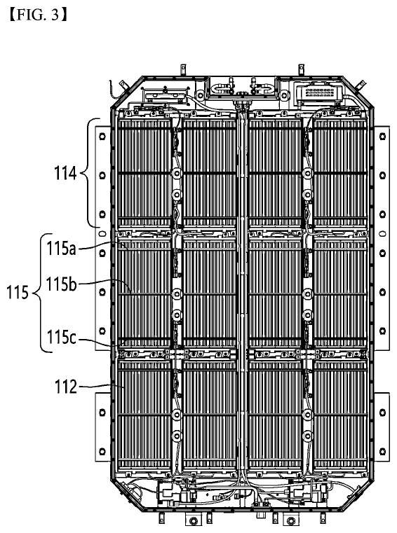

FIG. 1 is a perspective view illustrating a battery pack according to an embodiment of the present invention, FIG. 2 is an exploded perspective view of the battery pack shown in FIG. 1, and FIG. 3 is a diagram illustrating the upper surface of a battery module assembly according to an embodiment of the present invention.

Referring to FIGS. 1 and 2, the battery pack according to an embodiment of the present invention includes a battery module assembly (110) and a heat sink.

The battery module assembly (110) accommodates a battery module (114) within a case (111). The battery module (114) includes a battery cell assembly in which a plurality of battery cells (112) are stacked.

A plurality of battery modules (114) may be arranged in a matrix form within the case (111) with predetermined spacing between them. In FIG. 2, twelve battery modules (114) are arranged in a 3× 4 configuration; however, the number and arrangement of the battery modules (114) may be varied depending on the required capacity or design objectives.

As shown in FIG. 3, a fixing portion (115) may be formed in the battery module (114) according to the present invention to secure the stacked state of the battery cells (112).

In one embodiment of the present invention, the fixing portion (115) may be formed as a bar-shaped strap. The fixing portion (115) may be configured to wrap around the periphery of the stacked battery cells (112). In FIG. 3, three fixing portions (115a, 115b, 115c) are positioned at predetermined intervals. However, the shape, position, and number of the fixing portions (115) are not limited thereto.

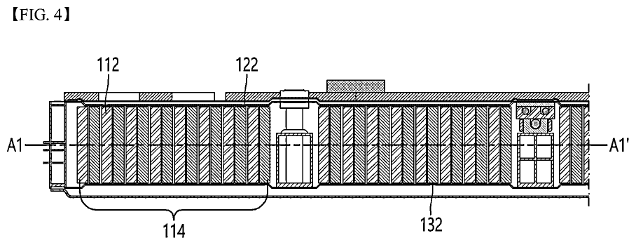

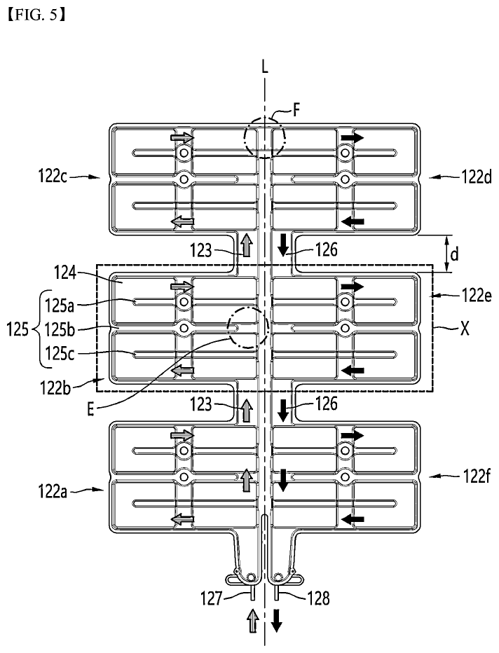

FIG. 4 is a cross-sectional view taken along line A1-A1′ of FIG. 1, and FIG. 5 is a diagram illustrating an upper cooling flow passage unit formed in an upper heat sink according to an embodiment of the present invention.

A heat sink according to an embodiment of the present invention includes an upper heat sink (120) and a lower heat sink (130).

Referring to FIGS. 2 and 4, the upper heat sink (120) covers the upper surface of the battery module assembly (110) and may cool the battery module (114). The upper heat sink (120) may have an upper cooling flow passage unit (122) formed along its surface direction.

The upper cooling flow passage unit (122) has a flow passage through which a cooling fluid may flow. The cooling fluid may be a highly efficient cooling fluid, such as cooling water with high latent heat to maximize cooling efficiency. However, the cooling fluid is not limited thereto and may include various fluids such as antifreeze, gaseous refrigerants, or air.

The width and thickness of the upper cooling flow passage unit (122) may be variably set.

The upper cooling flow passage unit (122) may be formed as a plurality of flow passages and may be interconnected to allow the cooling fluid to flow through them. In the embodiment shown in FIG. 5, the upper cooling flow passage unit (122) is symmetrically arranged with respect to a central reference line (L), where upper cooling flow passage units (122a, 122b, 122c) are formed on the left side and upper cooling flow passage units (122d, 122e, 122f) are formed on the right side.

In one embodiment of the present invention, a single upper cooling flow passage unit (122) may be configured to cool two battery modules (114). However, the number or shape of the upper cooling flow passage units (122) may be modified depending on the number or shape of the battery modules (114) to be cooled. For example, a certain upper cooling flow passage unit (122) may be configured to cool a single battery module, while another upper cooling flow passage unit (122) may be configured to cool one or more battery modules.

In one embodiment of the present invention, each upper cooling flow passage unit (122) includes a substantially U-shaped flow passage and has an overall rectangular shape. Specifically, each upper cooling flow passage unit (122) is formed with repeated U-shaped flow passages, wherein adjacent U-shaped flow passages are interconnected at opposing end positions (E).

In one embodiment of the present invention, the upper cooling flow passage units (122a, 122b, 122c or 122d, 122e, 122f), which are arranged in the direction of the reference line (L), are spaced apart by a predetermined distance (d) and are connected through connection flow passages (123, 126). This configuration considers cases where the battery modules (114) are arranged with spacing between them. The connection flow passages (123, 126) may be arranged in the direction of the reference line (L).

In one embodiment of the present invention, the upper cooling flow passage units (122a, 122b, 122c) disposed on the left side of the reference line (L) and the upper cooling flow passage units (122d, 122e, 122f) disposed on the right side are configured to face each other. A pair of upper cooling flow passage units (122c, 122d) that face each other are interconnected at opposing end positions (F).

In one embodiment of the present invention, an upper cooling flow passage unit (122a) disposed on the left side of the reference line (L) is connected to an inlet (127) through which the cooling fluid flows in, while an upper cooling flow passage unit (122f) disposed on the right side is connected to an outlet (128) through which the cooling fluid flows out.

In one embodiment of the present invention, each flow passage connected to the upper inlet (127) and upper outlet (128), along with the connection flow passages (123, 126), is arranged in a straight-line shape close to the reference line (L).

Referring to FIG. 5, each upper cooling flow passage unit (122) may include a first curved portion (124) bent in the direction toward the battery module (114) and a second curved portion (125) formed between the first curved portions (124) and bent in the opposite direction of the first curved portion (124).

The first curved portion (124) serves as a flow passage through which the cooling fluid flows. The cross-sectional shape of the first curved portion (124) may be variously formed as a circular, elliptical, or polygonal shape.

The second curved portion (125) is a region where the fixing portion (115), which protrudes above the upper surface of the battery module (114), may be inserted. The second curved portion (125) may have a shape that allows the fixing portion (115) to be inserted.

The first curved portion (124) has a first width, and the second curved portion (125) has a second width. In one embodiment of the present invention, the first width is greater than the second width.

The first curved portion (124) has a first height, and the second curved portion (125) has a second height. In one embodiment of the present invention, the first height is greater than the second height.

Of course, the widths and heights of the first curved portion (124) and the second curved portion (125) may be variably set.

In one embodiment of the present invention, each upper cooling flow passage unit (122) is formed with three second curved portions (125a, 125b, 125c) to allow the insertion of three fixing portions (115a, 115, 115b) formed in the battery module (114). However, the position and number of the fixing portions (115) may be determined based on the position and number of the second curved portions (125).

Referring to FIG. 5, the flow of the cooling fluid passing through the upper cooling flow passage unit (122) is described as follows. First, the cooling fluid introduced through the upper inlet (127) flows along the first upper cooling flow passage unit (122a) on the left side. At this time, the cooling fluid flows in a zigzag manner along the U-shaped flow passages and moves to the next upper cooling flow passage unit (122b) through the connection flow passage (123).

In this manner, after the cooling fluid has flowed through all the upper cooling flow passage units on the left side (122a, 122b, 122c), it moves to the upper cooling flow passage unit (122d) located on the right side. The cooling fluid then flows through all the upper cooling flow passage units on the right side (122d, 122e, 122f) via the connection flow passage (126) and is discharged through the upper outlet (128).

Referring to FIGS. 2 and 4, the lower heat sink (130) covers the lower surface of the battery module assembly (110) and is configured to cool the battery module (114). The lower heat sink (130) may have a lower cooling flow passage unit (132) formed along its surface direction.

In one embodiment of the present invention, the structure and function of the lower cooling flow passage unit (132) are the same as those of the upper cooling flow passage unit (122). Therefore, since the details of the lower cooling flow passage unit (132) may be sufficiently understood by referring to the descriptions of the upper cooling flow passage unit (122), a detailed explanation is omitted.

Meanwhile, according to another embodiment of the present invention, the flow passage thickness of the lower cooling flow passage unit (132) (or the degree of curvature of the first curved portion) may be formed thicker than the flow passage thickness of the upper cooling flow passage unit (122) (or the degree of curvature of the first curved portion). This is to prevent a decrease in cooling efficiency caused by the compression of the flow passage due to the force exerted by the battery module (114) pressing against the lower heat sink (130).

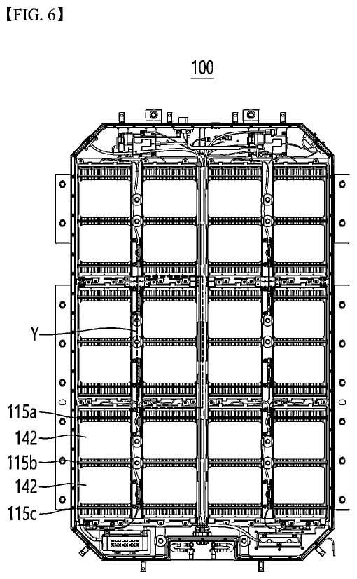

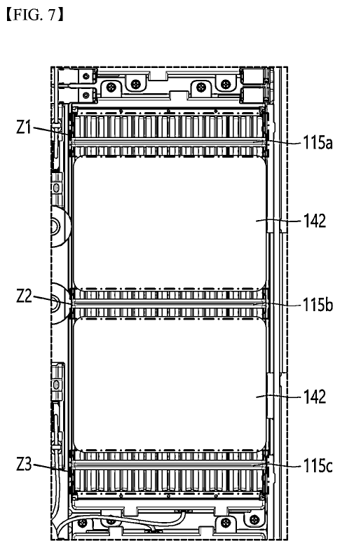

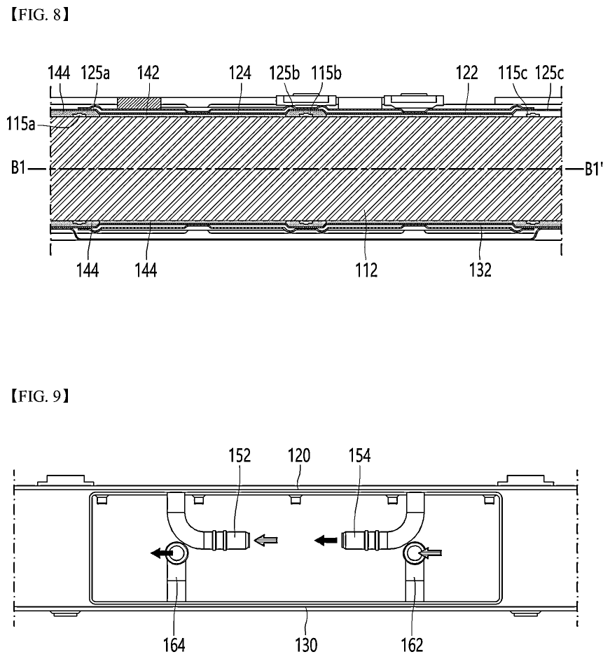

FIG. 6 is a diagram illustrating a state in which a pad-type gap filler is arranged on the upper surface of the battery module assembly according to the present invention. FIG. 7 is an enlarged view of portion Y shown in FIG. 6, and FIG. 8 is a cross-sectional view taken along line B1-B1′ of FIG. 1.

In general, during the implementation of a battery pack, a gap filler is used to prevent air gaps between the battery module and the heat sink and to efficiently transfer heat generated from the battery module to the heat sink. The gap filler (gap-filling material) also serves as an insulator and helps to compensate for assembly tolerances in the battery pack.

In one embodiment of the present invention, the gap filler may be positioned between the upper heat sink (120) and the upper surface of the battery module (114) or between the lower heat sink (130) and the lower surface of the battery module (114).

The gap filler may be classified into a pad type and a gel type based on its form and may be categorized as a solid or liquid based on its state. The gel-type gap filler is provided in an ointment-like form and, due to its flexible application, may achieve an equivalent level of thermal conductivity even with lower surface adhesion and a thinner layer compared to the pad-type gap filler. Additionally, the gel-type gap filler may melt into a liquid state when exposed to heat transferred from the battery module and may solidify back into an ointment or solid state when the battery module cools down.

In one embodiment of the present invention, the gap filler may be made of a thermal interface material (TIM) or a phase change material (PCM).

Referring to FIG. 6, a pad-type gap filler (142) may be positioned on the upper surface of the battery module (114). In one embodiment of the present invention, a single pad-type gap filler (142) may be positioned between two fixing portions (115) within a battery module (114). Alternatively, two pad-type gap fillers (142) may be positioned between three fixing portions (115). Preferably, the pad-type gap filler (142) may be positioned corresponding to the first curved portion (124). Of course, the number or shape of the pad-type gap fillers (142) may be variously configured depending on the size, shape, or number of fixing portions (115) of the battery module (114).

In one embodiment of the present invention, the pad-type gap filler (142) may not cover the entire upper surface of the battery module (114). As shown in FIG. 7, the pad-type gap filler (142) is positioned only in a specific region of the upper surface of the battery module (114), while the remaining regions (Z1, Z2, Z3) do not have the pad-type gap filler (142). In one embodiment of the present invention, a gel-type gap filler (144) may be applied to the remaining regions (Z1, Z2, Z3). Here, the remaining regions (Z1, Z2, Z3) may be spaces formed between the fixing portions (115a, 115b, 115c) and the second curved portions (125a, 125b, 125c), as shown in FIG. 8.

According to another embodiment of the present invention, the pad-type gap filler (142) may be positioned to cover the entire upper surface of the battery module (114).

A gel-type gap filler (144) may be applied between the lower heat sink (130) and the lower surface of the battery module (114). The gel-type gap filler (144) may be applied over the entire lower surface of the battery module (114).

FIG. 9 is a diagram illustrating the state of the inlet and outlet ports according to an embodiment of the present invention, and FIG. 10 is a diagram illustrating the state of the inlet and outlet ports according to another embodiment of the present invention.

Referring to FIG. 9, in one embodiment of the present invention, an upper inlet port (152) connected to the inlet (127) is formed in the upper heat sink (120), and an upper outlet port (154) connected to the upper outlet (128) is formed. Additionally, a lower inlet port (162) connected to the lower inlet and a lower outlet port (164) connected to the lower outlet are formed in the lower heat sink (130).

In one embodiment of the present invention, each of the ports (152, 154, 162, 164) is separately configured. That is, according to one embodiment of the present invention, two inlet ports (152, 162) are formed to allow cooling fluid to be introduced into the battery pack (100), and two outlet ports (154, 164) are formed to allow cooling fluid to be discharged from the battery pack (100).

Meanwhile, in FIG. 9, the lower outlet port (164) is positioned below the upper inlet port (152), and the lower inlet port (162) is positioned below the upper outlet port (154). However, the lower inlet port (162) may be positioned below the upper inlet port (152), and the lower outlet port (164) may be positioned below the upper outlet port (154).

Referring to FIG. 10, in another embodiment of the present invention, the upper inlet port (152) and the lower inlet port (162) are interconnected through a connecting pipe (171), and the connecting pipe (171) is connected to an integrated inlet port (182). Similarly, the upper outlet port (154) and the lower outlet port (164) are interconnected through a connecting pipe (172), and the connecting pipe (172) is connected to an integrated outlet port (184).

Here, the connecting pipes (171, 172) serve as branching pipes that allow the cooling fluid to flow through the inlet and outlet ports formed on the upper and lower portions. That is, according to another embodiment of the present invention, a single inlet port (182) is formed to introduce cooling fluid into the battery pack (100), and a single outlet port (184) is formed to discharge cooling fluid from the battery pack (100).

Meanwhile, in conventional systems, multiple branch ports connected to heat sinks mounted on battery modules were formed in addition to the main inlet and outlet ports for cooling the battery pack. As a result, there was a high risk of cooling fluid leakage due to pipe damage. However, according to the present invention, branch ports are not required, and the number of main inlet ports may be minimized, thereby effectively addressing the aforementioned issue.

### Second Embodiment

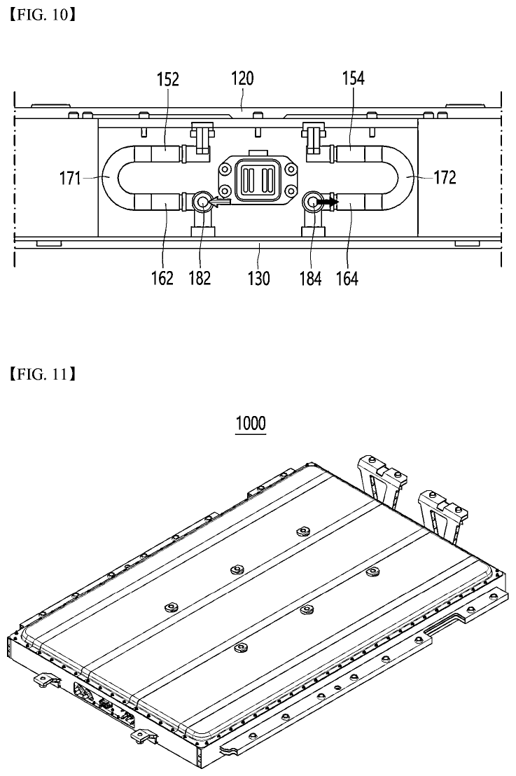

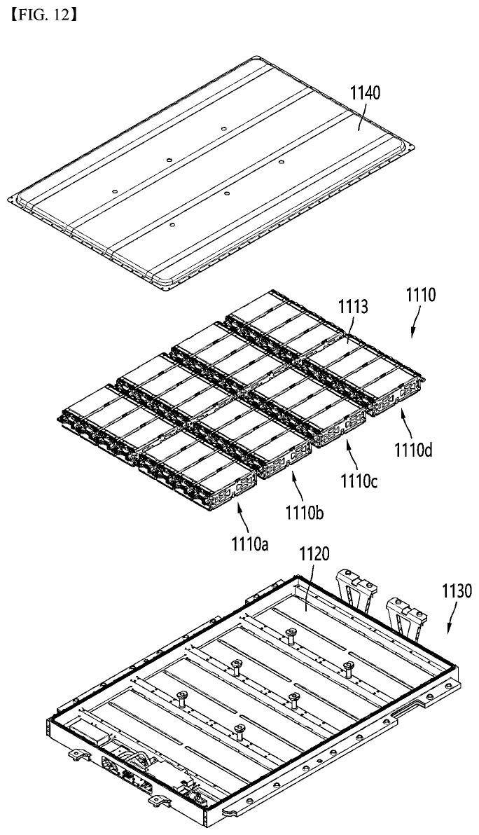

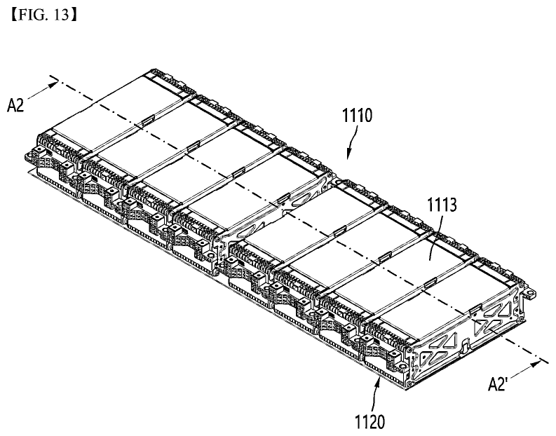

FIG. 11 is a perspective view illustrating a battery pack according to an embodiment of the present invention, FIG. 12 is an exploded perspective view of a battery pack according to an embodiment of the present invention, and FIG. 13 is a diagram illustrating a state in which a heat sink is mounted on a battery module assembly according to an embodiment of the present invention.

Referring to FIGS. 11 to 13, a battery pack (1000) according to an embodiment of the present invention includes a battery module assembly (1110), a heat sink (1120), a housing (1130), and a cover (1140).

The battery module assembly (1110) comprises a plurality of battery modules (1113). Each battery module (1113) may be formed in a structure in which multiple battery cells are repeatedly arranged in a predetermined direction. Here, a battery cell is a component where electrical charging and discharging occur, and it may be structured such that multiple unit cells are arranged in a predetermined direction in a repeated manner.

Meanwhile, although the battery module (1113) may be used in various devices requiring a battery, in this embodiment, it is described as being used in the battery pack of an electric vehicle for ease of explanation.

The battery module assembly (1110) may be assembled such that a plurality of battery modules (1113) are arranged in a predetermined direction and interconnected. Referring to FIG. 12, in one embodiment of the present invention, the battery module assembly (1110) includes eight battery modules (1113) arranged in a left-right direction, forming a single battery module unit assembly (1110a, 1110b, 1110c, 1110d). These battery module unit assemblies (1110a, 1110b, 1110c, 1110d) may be arranged in four rows in the front-rear direction.

Of course, the number or arrangement of the battery modules (1113) constituting the battery module unit assemblies (1110a, 1110b, 1110c, 1110d), as well as the number or arrangement of the battery module unit assemblies (1110a, 1110b, 1110c, 1110d) themselves, may be variably configured.

The heat sink (1120) is a component configured to dissipate heat generated from the battery cells to the outside and may be arranged in the battery module assembly (1110). As shown in FIG. 13, in one embodiment of the present invention, the heat sink (1120) may be provided in a rectangular plate shape and arranged to cover the lower surface of the battery module assembly (1110). Accordingly, heat generated from the battery cells or battery modules (1113) may be transferred to the heat sink (1120) disposed at the lower side and then dissipated to the outside.

The heat sink (1120) may be arranged corresponding to each battery module unit assembly (1110a, 1110b, 1110c, 1110d). In one embodiment of the present invention, four heat sinks (1120) may be disposed on the lower surfaces of the four battery module unit assemblies (1110a, 1110b, 1110c, 1110d). For example, if n battery module unit assemblies are arranged, n heat sinks (1120) may be arranged accordingly.

Meanwhile, the heat sink (1120) may also be arranged on the upper surface or side surfaces of the battery module assembly (1110). Additionally, the shape of the heat sink (1120) may vary depending on the shape of the surface in contact with the battery module assembly (1110), and there is no limitation on the number of heat sinks (1120) that may be arranged in the battery module assembly (1110).

Furthermore, a gap filler with excellent thermal conductivity may be used between the heat sink (1120) and the battery module assembly (1110) to eliminate any gaps that may exist between the heat sink (1120) and the battery module (1113).

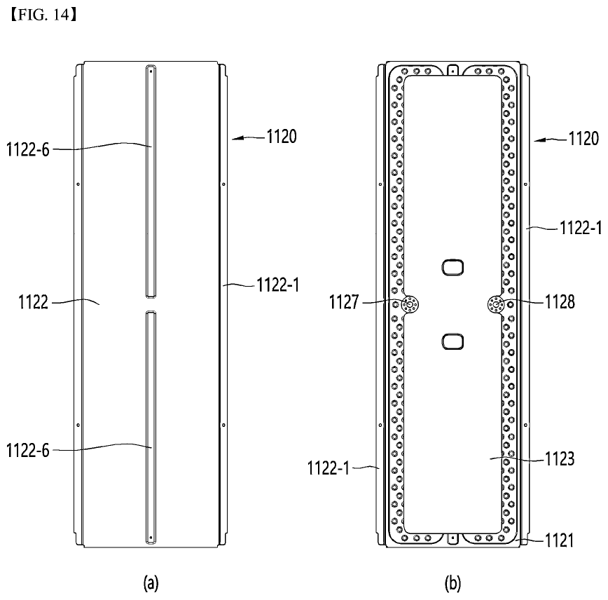

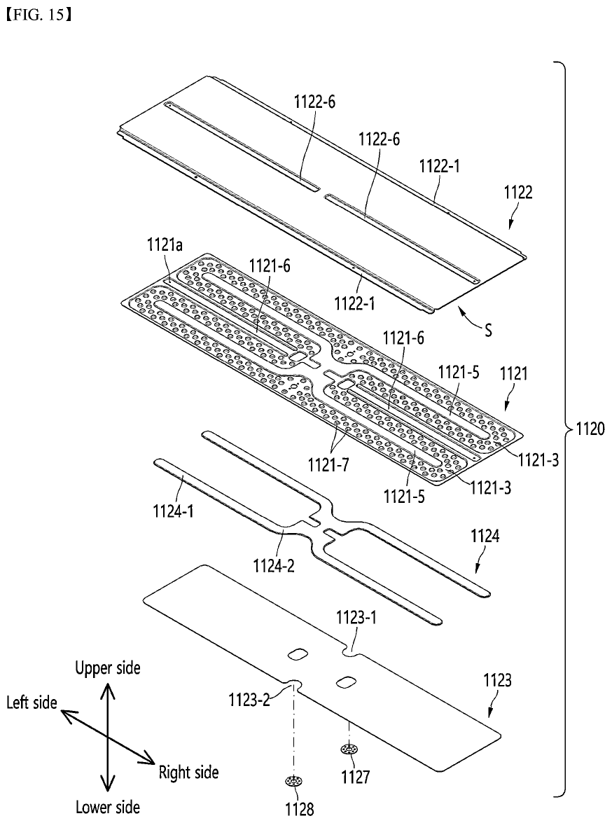

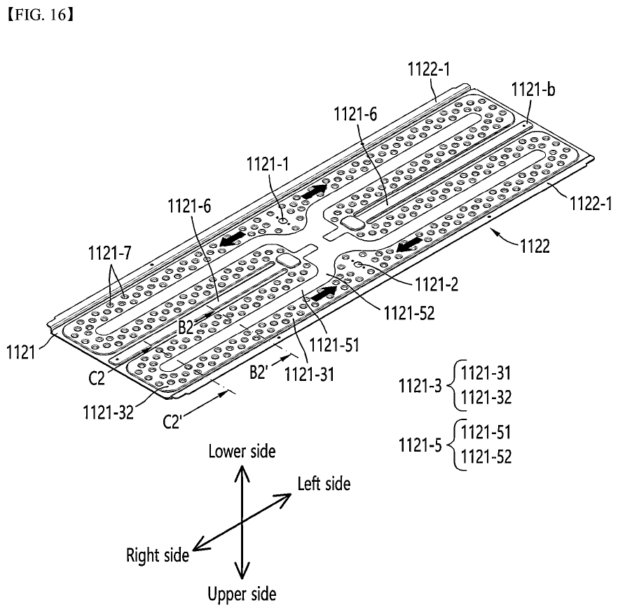

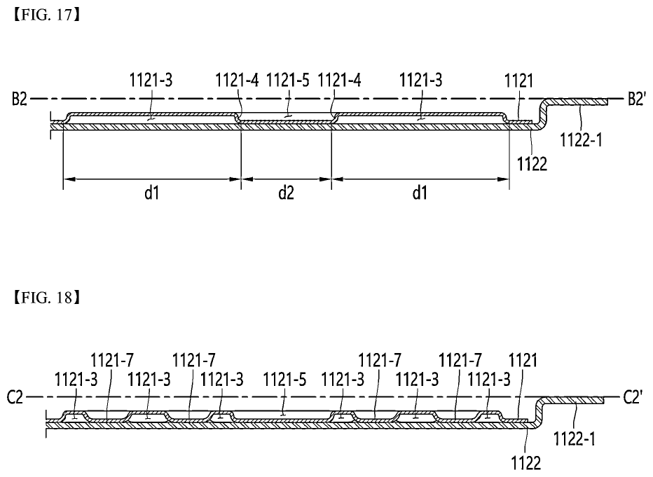

FIG. 14 is a diagram illustrating the upper and lower surfaces of a heat sink according to an embodiment of the present invention. FIG. 15 is an exploded perspective view of a heat sink according to an embodiment of the present invention. FIG. 16 is a diagram illustrating the lower surface of a first plate according to the present invention. FIG. 17 is a cross-sectional view taken along line B2-B2′ of FIG. 16, and FIG. 18 is a cross-sectional view taken along line C2-C2′ of FIG. 16.

FIG. 14 illustrates the assembled state of the heat sink (1120), where FIG. 14(a) shows the upper surface of the heat sink (1120) and FIG. 14(b) shows the lower surface of the heat sink (1120). In one embodiment of the present invention, the upper surface of the heat sink (1120) may be arranged to face the lower surface of the battery module assembly (1110), while the lower surface of the heat sink (1120) may be arranged to face the lower surface of the housing (1130).

Referring to FIG. 15, the heat sink (1120) includes a first plate (1121), a second plate (1122), a third plate (1123), and a heat-absorbing material (1124).

The first plate (1121) may have a flow passage unit (1121-3) through which a cooling fluid may flow, which may be formed by a pressing process. The first plate (1121) is disposed between the second plate (1122) and the third plate (1123).

When viewing the upper surface (1121-a) of the first plate (1121), the flow passage unit (1121-3) may have a recessed concave shape, depressed in the downward direction relative to the upper surface (1121-a) of the first plate (1121). Conversely, when viewing the lower surface (1121-b) of the first plate (1121), the flow passage unit (1121-3) may have a protruding shape extending downward relative to the lower surface (1121-b) of the first plate (1121).

The flow passage unit (1121-3) may include a recessed bottom surface, side surfaces connected to the bottom surface, and an open surface opposite the bottom surface.

As shown in FIG. 17, the flow passage unit (1121-3) may have a partition wall (1121-4) along its length direction with a constant height on its side surfaces and a space with a cross-sectional width (d1). This space serves as a passage through which the cooling fluid may flow.

Of course, the partition wall (1121-4) and the cross-sectional width (d1) of the flow passage unit (1121-3) may be formed differently along the flow direction.

Meanwhile, the flow passage unit (1121-3) may include embossments (1121-4) to induce turbulence in the cooling fluid. When viewing the upper surface of the first plate (1121), the embossments (1121-4) may have a protruding shape extending upward relative to the upper surface of the first plate (1121). Conversely, when viewing the lower surface (1121-b) of the first plate (1121), the embossments (1121-4) may have a recessed concave shape extending downward relative to the lower surface (1121-b) of the first plate (1121).

The embossments (1121-4) are formed in a dot pattern; however, the shape of the embossments (1121-4) is not limited thereto.

The first plate (1121) includes an accommodation portion (1121-5) configured to accommodate a phase change material (1124). The accommodation portion (1121-5) may be formed in regions of the first plate (1121) other than the area where the flow passage unit (1121-3) is formed.

When viewing the upper surface of the first plate (1121), the accommodation portion (1121-5) may have a protruding shape extending upward relative to the upper surface (1121-a) of the first plate (1121). Conversely, when viewing the lower surface (1121-b) of the first plate (1121), the accommodation portion (1121-5) may have a recessed concave shape extending downward relative to the lower surface (1121-b) of the first plate (1121).

The accommodation portion (1121-5) may include a recessed bottom surface, side surfaces connected to the bottom surface, and an open surface opposite the bottom surface.

As shown in FIG. 17, the accommodation portion (1121-5) may include a space having a partition wall (1121-4) with a constant height along its length direction and a cross-sectional width (d2). This space may accommodate the heat-absorbing material (1124).

Here, the accommodation portion (1121-5) may share the partition wall (1121-4) formed in the flow passage unit (1121-3). Of course, the height of the partition wall (1121-4) in the accommodation portion (1121-5) may vary depending on the height of the partition wall (1121-4) in the flow passage unit (1121-3), and the cross-sectional width (d2) may vary depending on the region where the accommodation portion (1121-5) is formed.

Referring to FIG. 16, in one embodiment of the present invention, the flow passage unit (1121-3) includes a linear flow passage unit (1121-31) formed in a straight direction and a curved flow passage unit (1121-32) that changes the flow direction.

In one embodiment of the present invention, the flow passage unit (1121-3) is configured symmetrically such that the linear flow passage units (1121-31) and the curved flow passage units (1121-32), which are formed on both sides (left and right in FIG. 16) of the first plate (1121) relative to its center, face each other.

According to one embodiment of the present invention, the linear flow passage units (1121-31), which are positioned at the outermost regions in the width direction of the first plate (1121) and arranged to face each other in the longitudinal direction, may be formed to be in fluid communication with each other. Additionally, the linear flow passage units (1121-31) positioned on the inner side in the width direction of the first plate (1121) and arranged to face each other in the width direction may be formed to be in fluid communication with each other near the center of the first plate (1121) via the curved flow passage unit (1121-32).

However, according to another embodiment of the present invention, there is no limitation on the number or arrangement direction of the linear flow passage unit (1121-31) or the curved flow passage unit (1121-32).

For example, the linear flow passage units (1121-31) formed on both sides of the first plate (1121) relative to its center may be arranged in the width direction of the first plate (1121). Additionally, the flow passage units (1121-3) formed on both sides of the first plate (1121) relative to its center may be asymmetrically arranged. Furthermore, the linear flow passage unit (1121-31) and the curved flow passage unit (1121-32) may be formed across the entire area of the first plate (1121).

The flow passage unit (1121-3) includes an inlet hole (1121-1) through which the cooling fluid is introduced from the outside into the flow passage unit (1121-3) and an outlet hole (1121-2) through which the cooling fluid is discharged from the flow passage unit (1121-3) to the outside.

Referring to the arrow directions shown in FIG. 16, the cooling fluid introduced through the inlet hole (1121-1) moves toward both sides (left and right in FIG. 16), then passes through the linear flow passage units and the curved flow passage units, and finally gathers at the outlet hole (1121-2) before being discharged to the outside.

In one embodiment of the present invention, the inlet hole (1121-1) and the outlet hole (1121-2) may be formed on the linear flow passage units (1121-31) located at the outermost regions.

The accommodation portion (1121-5) of the present invention includes a linear accommodation portion (1121-51) formed in a straight direction and a curved accommodation portion (1121-52).

The accommodation portion (1121-5) may be determined based on the shape of the flow passage unit (1121-3). In one embodiment of the present invention, the accommodation portion (1121-5) may be symmetrically formed such that the linear accommodation portions (1121-51) and the curved accommodation portions (1121-52), which are formed on both sides (left and right in FIG. 16) of the first plate (1121) relative to its center, face each other.

Meanwhile, as shown in FIG. 17, in one embodiment of the present invention, the partition wall (1121-4) forms the side surfaces of the groove in the flow passage unit (1121-3) or the accommodation portion (1121-5) and may have an inclined shape with respect to the first plate (1121). It may also be formed in a straight shape in the vertical direction.

However, the partition wall (1121-4) is inclined such that the spacing between the partition walls (1121-4) narrows as they approach the first plate (1121), although the opposite configuration is also possible. The partition wall (1121-4) may have multiple inclined surfaces with different angles, or it may have at least one of an inclined shape, a straight shape, or a curved shape.

The heat-absorbing material is a substance that induces an endothermic reaction when the temperature of the battery module (1113) or the heat sink (1120) rises above a predetermined temperature.

For example, the heat-absorbing material may include paraffin, polyethylene glycol, and inorganic hydrates (e.g., Na₂HPO₄·12H₂O, Na₂SO₄·10H₂O, Zn(NO₃)₂·6H₂O, etc.), but it is not limited thereto.

In this specification, a phase change material is provided as an example of such a heat-absorbing material. A phase change material undergoes a phase transition at a predetermined temperature, preferably transitioning from a solid phase to a liquid phase or from a solid phase to a gas phase, and retains latent heat through this phase transition.

The phase change material (1124) includes a material that undergoes a phase change while absorbing heat generated from the battery cells or battery module (1113), utilizing the latent heat required for the phase change to perform heat absorption and storage functions. At this time, the phase change material (1124) may undergo a phase change when the temperature exceeds a certain threshold.

Referring to FIG. 15, the phase change material (1124) is accommodated in the accommodation portion (1121-5). In one embodiment of the present invention, the phase change material (1124) may be accommodated throughout the entire area of the accommodation portion (1121-5), but it may also be accommodated only in a partial region of the accommodation portion (1121-5).

The phase change material (1124) includes a linear portion (1124-1) and a curved portion (1124-2). The linear portion (1124-1) may be accommodated in the linear accommodation portion (1121-51), and the curved portion (1124-2) may be accommodated in the curved accommodation portion (1121-52).

Meanwhile, the phase change material (1124) may be configured in the form of a capsule member made of an elastic material. It is preferable that the phase change material (1124) is formed of a material capable of undergoing a phase change while absorbing heat at a temperature lower than the fire ignition temperature of the battery cell.

In another embodiment, the phase change material (1124) may further include a thermal interface material (TIM) to enhance heat transfer performance.

In one embodiment of the present invention, the phase change material (1124) may be in a solid state to maintain its form. However, it is not limited thereto, and the phase change material (1124) may also be formed in a liquid state.

The first plate (1121) may include a first plate alignment portion (1121-6). The first plate alignment portion (1121-6) may have a shape insertable into a second plate alignment portion (1122-6), which will be described later.

When viewing the upper surface (1121-a) of the first plate (1121), the first plate alignment portion (1121-6) may have a recessed concave shape that is depressed downward relative to the upper surface (1121-a) of the first plate (1121). Conversely, when viewing the lower surface (1121-b) of the first plate (1121), the first plate alignment portion (1121-6) may have a protruding shape extending downward relative to the lower surface (1121-b) of the first plate (1121).

The first plate alignment portion (1121-6) may include a recessed bottom surface, side surfaces connected to the bottom surface, and an open surface opposite the bottom surface.

The second plate (1122) is coupled to the first plate (1121) to cover its upper surface. As described above, the upper surface of the flow passage unit (1121-3) of the first plate (1121) is exposed to the outside. When the first plate (1121) and the second plate (1122) are coupled, the upper surface of the flow passage unit (1121-3) is sealed, thereby completing a passage through which the cooling fluid may flow. In other words, the second plate (1122) prevents the loss of cooling fluid.

The second plate (1122) may include a second plate alignment portion (1122-6). When viewing the upper surface of the second plate (1122), the second plate alignment portion (1122-6) may have a recessed concave shape that is depressed downward relative to the upper surface of the second plate (1122).

When the second plate alignment portion (1122-6) is inserted into the first plate alignment portion (1121-6), the first plate (1121) and the second plate (1122) may be aligned and coupled in the desired arrangement as designed.

At both ends in the width direction of the second plate (1122), an outer portion (1122-1) extending in the longitudinal direction (left and right directions as shown in FIG. 15) may be formed. The outer portion (1122-1) may be formed by extending in a bent state from both ends in the width direction of the second plate (1122). Due to the outer portion (1122-1), a seating space(S) may be formed in the second plate (1122), allowing the first plate (1121) to be seated.

The third plate (1123) is coupled to the first plate (1121) to cover its lower surface. As described above, the lower surface of the accommodation portion (1121-5) of the first plate (1121) is exposed to the outside. When the first plate (1121) and the third plate (1123) are coupled, the lower surface of the accommodation portion (1121-5) is sealed, thereby completing the space for accommodating the phase change material (1124). In other words, the third plate (1123) prevents the loss of the phase change material (1124).

When the phase change material (1124) is in a solid state (e.g., in a paste form), it may be shaped according to the form of the accommodation portion (1121-5) of the first plate (1121) and then accommodated in the accommodation portion (1121-5), after which the third plate (1123) may be coupled to the first plate (1121).

When the phase change material (1124) is in a liquid state, it may be applied to the accommodation portion (1121-5) of the first plate (1121), after which the third plate (1123) may be coupled to the first plate (1121).

In one embodiment of the present invention, the third plate (1123) may be formed only in the region of the lower surface of the first plate (1121) where the phase change material (1124) is accommodated. However, it is not limited thereto, and the third plate (1123) may also be configured to cover the entire lower surface of the first plate (1121).

Referring again to FIG. 15, the third plate (1123) includes an inlet port recess (1123-1) and an outlet port recess (1123-2). The inlet port recess (1123-1) may be formed at a position corresponding to the inlet hole (1121-1) of the first plate (1121), and the outlet port recess (1123-2) may be formed at a position corresponding to the outlet hole (1121-2) of the first plate (1121).

The inlet port recess (1123-1) is formed to allow an inlet port (1127) to be mounted on the lower surface of the first plate (1121), while the outlet port recess (1123-2) is formed to allow an outlet port (1128) to be mounted on the lower surface of the first plate (1121).

The inlet port (1127) serves as a connection port for introducing cooling fluid from the outside into the flow passage unit (1121-3) of the first plate (1121) and is connected to the inlet hole (1121-1). The outlet port (1128) serves as a connection port for discharging the cooling fluid from the flow passage unit (1121-3) to the outside and is connected to the outlet hole (1121-2).

The assembly process of the first to third plates (1121, 1122, 1123) is described below.

In one embodiment of the present invention, the first to third plates (1121, 1122, 1123) may be made of a metal material. For example, the first to third plates (1121, 1122, 1123) may be composed of aluminum.

In one embodiment of the present invention, the first plate (1121) and the second plate (1122) may be joined using a brazing process, while the first plate (1121) and the third plate (1123) may be joined using a welding method, such as laser welding, or by using an adhesive.

Meanwhile, according to another embodiment of the present invention, the first and second plates (1121, 1122) may be made of a metal material, while the third plate (1123) may be formed of a film material. Here, the film material of the third plate (1123) may be a thermoplastic material.

In another embodiment of the present invention, the first plate (1121) and the second plate (1122) may be joined using a brazing process, while the first plate (1121) and the third plate (1123) may be joined using an adhesive or by melting the film material and attaching it to the first plate (1121).

When the third plate (1123) includes a film material, it may have a smaller thickness than the first or second plates (1121, 1122).

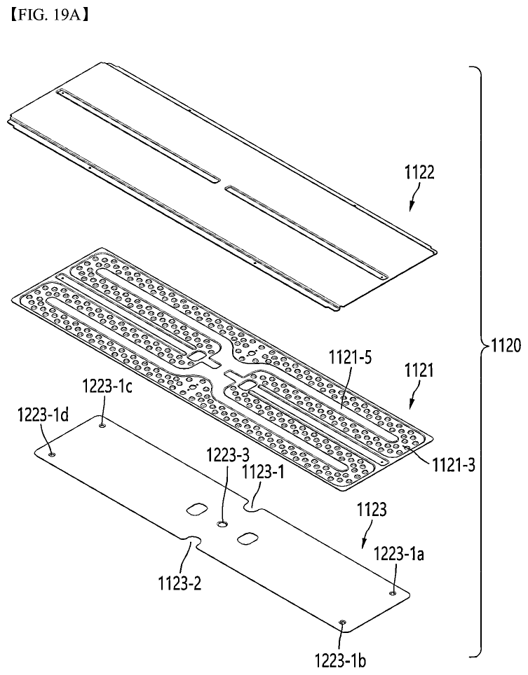

FIGS. 19A and 19B are diagrams illustrating a heat sink according to another embodiment of the present invention.

Referring to FIGS. 19A and 19B, the heat sink (1120) according to another embodiment of the present invention differs from the heat sink (1120) described in one embodiment of the present invention in terms of the configuration of the third plate (1123).

This difference in configuration arises from the method of accommodating the phase change material (1124) in the accommodation portion (1121-5), and the method for accommodating the phase change material (1124) will be described later.

Hereinafter, the description of the remaining components of the heat sink (1120) will be omitted, and only the differing configurations will be explained.

In another embodiment of the present invention, the third plate (1123) includes an injection port (1223-3) and a suction port (1223-1). The injection port (1223-3) is a port for injecting the phase change material (1124) into the accommodation portion (1121-5), while the suction port (1223-1) is a port for removing air present in the accommodation portion (1121-5).

By suctioning the air from the accommodation portion (1121-5) through the suction port (1223-1) and then injecting the phase change material (1124) through the injection port (1223-3), the phase change material (1124) may be smoothly introduced into the accommodation portion (1121-5).

In the present invention, the injection port (1223-3) is formed approximately at the center of the third plate (1123), while the suction ports (1223-1a, 1223-1b, 1223-1c, 1223-1d) are formed at each corner of the third plate (1123).

The arrangement of the injection port (1223-3) and the suction ports (1223-1a, 1223-1b, 1223-1c, 1223-1d) is designed to facilitate the injection of the phase change material (1124) from the center of the first plate (1121) toward the corners, as the accommodation portion (1121-5) is symmetrically formed on both sides relative to the center of the first plate (1121).

Of course, the number and arrangement of the injection port (1223-3) and the suction ports (1223-1a, 1223-1b, 1223-1c, 1223-1d) may be variably configured.

Meanwhile, after the injection port (1223-3) and the suction ports (1223-1a, 1223-1b, 1223-1c, 1223-1d) have been used, they may be configured to be sealed.

Referring again to FIG. 12, the battery module assembly (1110) is accommodated within the internal space of the housing (1130). The internal space of the housing (1130) may be partitioned to accommodate each battery module sub-assembly (1110a, 1110b, 1110c, 1110d).

When the battery module sub-assemblies (1110a, 1110b, 1110c, 1110d) are accommodated in the housing (1130), a cover (1140) may be coupled to the upper surface of the housing (1130).

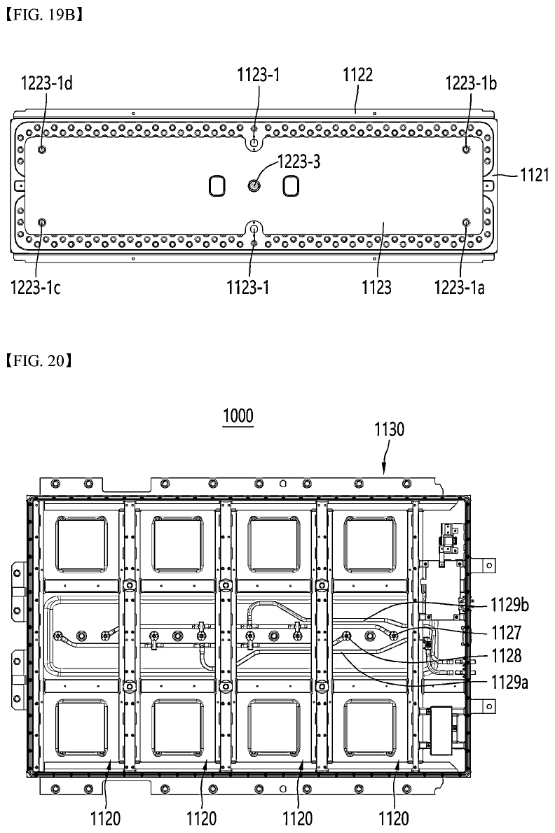

FIG. 20 is a bottom view illustrating the lower surface of the battery pack according to the present invention.

When examining the lower surface of the battery pack (1000) in its completed state, a pipe (1129a) connecting each inlet port (1127) formed in the heat sink (1120) and a pipe (1129b) connecting each outlet port (1128) are formed.

The cooling fluid supplied from the exterior of the battery pack (1000) moves along the pipe (1129a) and enters the interior of the heat sink (1120) through the inlet hole (1121-1) of the heat sink (1120). More specifically, the cooling fluid flows into the flow passage unit (1121-3), which is a space between the first plate (1121) and the second plate (1122). After traveling through the interior of the heat sink (1120), the cooling fluid moves along the pipe (1129b) and is discharged to the exterior of the battery pack (1000).

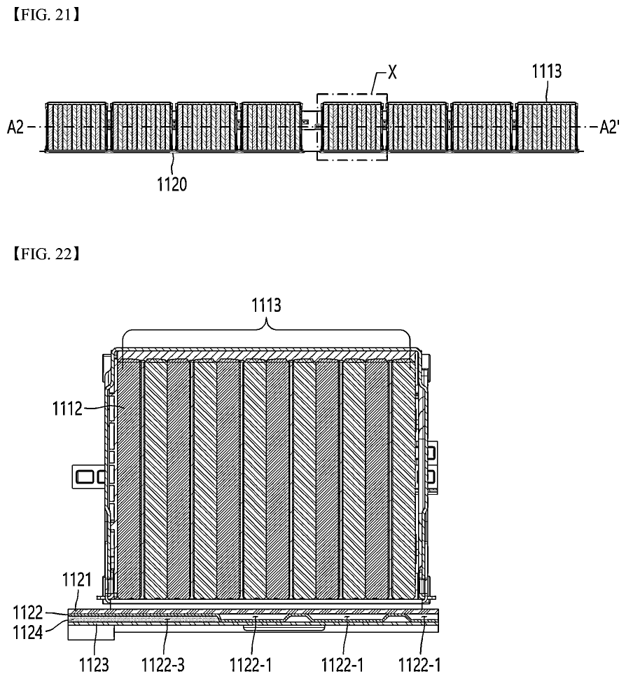

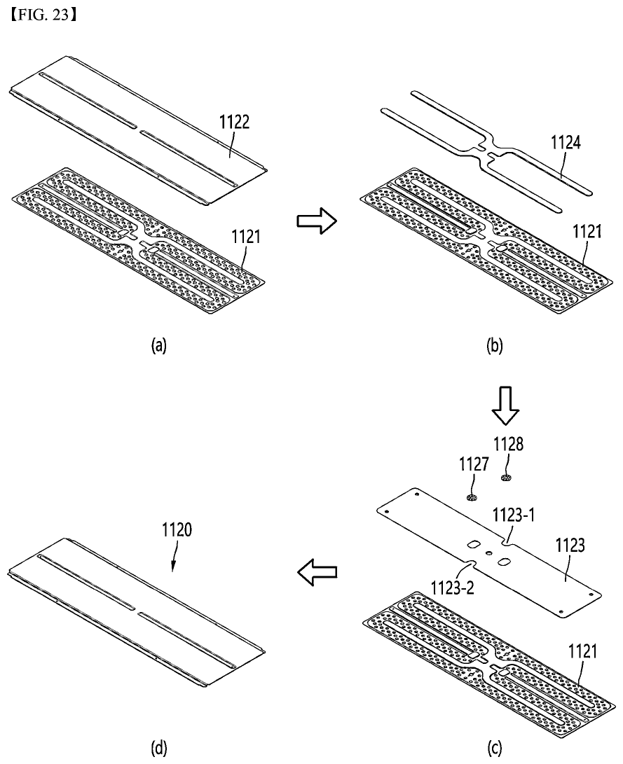

FIG. 21 is a cross-sectional view taken along line A2-A2′ shown in FIG. 13, and FIG. 22 is an enlarged view of portion X shown in FIG. 21.

Referring to FIGS. 21 and 22, since the heat sink (1120) is mounted on the lower surface of the battery module (1113) according to the present invention, heat generated from the battery cells (1112) or the battery module (1113) moves downward and is transferred to the heat sink (1120).

At this time, the accommodation portion (1121-5) of the heat sink (1120) contains the phase change material (1124), while the flow passage unit (1122-1) allows cooling fluid to flow. The heat generated from the battery cells (1112) or the battery module (1113) is initially dissipated through the cooling fluid, and when the temperature exceeds a certain threshold, the phase change material undergoes a phase transition while absorbing heat.

Accordingly, this dual cooling mechanism prevents a rapid temperature rise in the battery cells (1112) or the battery module (1113).

Meanwhile, in a vehicle cooling water system, increasing the flow rate of the cooling water is necessary to rapidly lower the heat generated by the battery. However, achieving this requires increasing the capacity of the radiator and pump, which in turn leads to an increase in the layout volume and weight of the cooling system.

According to the present invention, since the phase change material (1124) is formed in regions of the heat sink (1120) other than the area where the flow passage unit (1121-3) is formed, heat generated from the battery cells or the battery module may be effectively cooled through a dual cooling method using both the cooling fluid and the phase change material, without the need to increase the capacity of the radiator and pump.

Additionally, increasing the size of the flow passage unit is typically necessary to rapidly lower the heat generated by the battery. However, in the present invention, dual cooling using the phase change material eliminates the need to enlarge the flow passage unit.

Furthermore, according to the present invention, since the phase change material (1124) is accommodated in the accommodation portion (1121-5), which is the remaining space of the first plate (1121) after the formation of the flow passage unit (1121-3), there is no need to separately process additional space in the first plate (1121) to accommodate the phase change material (1124).

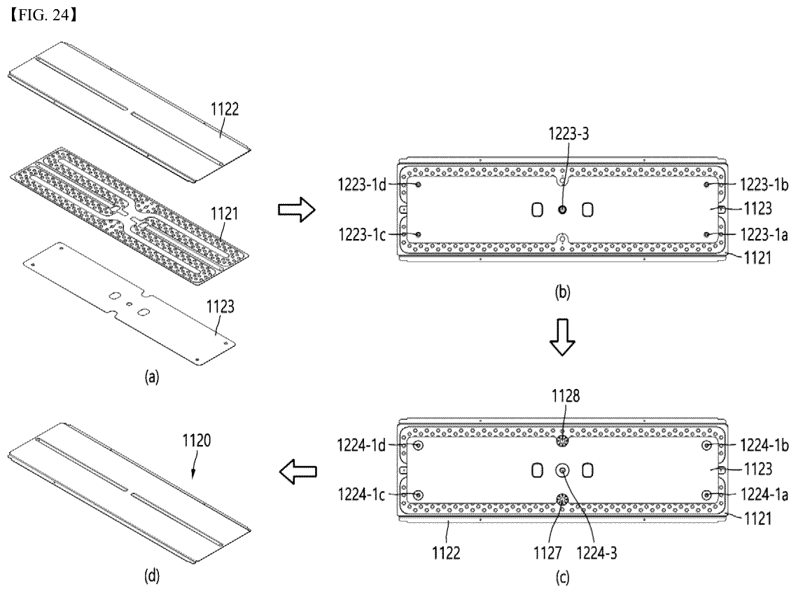

FIG. 23 is a diagram illustrating the assembly process of a heat sink according to one embodiment of the present invention, and FIG. 24 is a diagram illustrating the assembly process of a heat sink according to another embodiment of the present invention.

Referring to FIG. 23, the assembly process of the heat sink (1120) according to one embodiment of the present invention is described.

First, as shown in FIG. 23(a), the second plate (1122) is coupled to the surface of the first plate (1121) where the grooves of the flow passage unit (1121-3) are formed.

Next, as shown in FIG. 23(b), the phase change material (1124) is placed on the opposite surface of the first plate (1121), where the grooves of the accommodation portion (1121-5) are formed. Here, the phase change material (1124) may be in a liquid or solid state.

If the phase change material (1124) is in a solid state (e.g., in a paste form), its shape may conform to the shape of the accommodation portion (1121-5), and it may be inserted into the grooves of the accommodation portion (1121-5). If the phase change material (1124) is in a liquid state, it may be applied to the grooves of the accommodation portion (1121-5).

Subsequently, as shown in FIG. 23(c), the third plate (1123) is coupled to the opposite surface of the first plate (1121). Then, the inlet port (1127) and the outlet port (1128) are coupled to the inlet port recess (1123-1) and the outlet port recess (1123-2) of the third plate (1123), respectively.

Finally, as shown in FIG. 23(d), the heat sink (1120) according to one embodiment of the present invention is assembled.

Next, referring to FIG. 24, the assembly process of the heat sink (1120) according to another embodiment of the present invention is described.

First, as shown in FIG. 24(a), the second plate (1122) is coupled to the surface of the first plate (1121) where the grooves of the flow passage unit (1121-3) are formed, and the third plate (1123) is coupled to the opposite surface of the first plate (1121) where the grooves of the accommodation portion (1121-5) are formed.

Next, as shown in FIG. 24(b), the phase change material (1124) is injected into the space within the accommodation portion (1121-5) through the injection port (1223-3), while simultaneously, air inside the accommodation portion (1121-5) is drawn out through the suction ports (1223-1a, 1223-1b, 1223-1c, 1223-1d).

As a result, the phase change material (1124) moves from the location of the injection port (1223-3) to the locations of the suction ports (1223-1a, 1223-1b, 1223-1c, 1223-1d), filling the space of the accommodation portion (1121-5). Here, the phase change material (1124) may be in a liquid state or a solid state in paste form.

Subsequently, as shown in FIG. 24(c), an injection port cap (1224-3) is coupled to the injection port (1223-3), and suction port caps (1224-1a, 1224-1b, 1224-1c, 1224-1d) are coupled to the suction ports (1223-1a, 1223-1b, 1223-1c, 1223-1d). The injection port cap (1224-3) and the suction port caps (1224-1a, 1224-1b, 1224-1c, 1224-1d) function to prevent the phase change material (1124) accommodated in the accommodation portion (1121-5) from leaking to the outside.

Finally, as shown in FIG. 24(d), the heat sink (1120) according to another embodiment of the present invention is assembled.

Next, referring to FIG. 24, the assembly process of the heat sink (1120) according to another embodiment of the present invention is described.

First, as shown in FIG. 24(a), the second plate (1122) is coupled to the surface of the first plate (1121) where the grooves of the flow passage unit (1121-3) are formed, and the third plate (1123) is coupled to the opposite surface of the first plate (1121) where the grooves of the accommodation portion (1121-5) are formed.

Next, as shown in FIG. 24(b), the phase change material (1124) is injected into the space within the accommodation portion (1121-5) through the injection port (1223-3), while simultaneously, air inside the accommodation portion (1121-5) is drawn out through the suction ports (1223-1a, 1223-1b, 1223-1c, 1223-1d).

As a result, the phase change material (1124) moves from the location of the injection port (1223-3) toward the locations of the suction ports (1223-1a, 1223-1b, 1223-1c, 1223-1d), filling the space of the accommodation portion (1121-5). Here, the phase change material (1124) may be in a liquid state or a solid state in paste form.

Subsequently, as shown in FIG. 24(c), an injection port cap (1224-3) is coupled to the injection port (1223-3), and suction port caps (1224-1a, 1224-1b, 1224-1c, 1224-1d) are coupled to the suction ports (1223-1a, 1223-1b, 1223-1c, 1223-1d). The injection port cap (1224-3) and the suction port caps (1224-1a, 1224-1b, 1224-1c, 1224-1d) function to prevent the phase change material (1124) accommodated in the accommodation portion (1121-5) from leaking to the outside.

Finally, as shown in FIG. 24(d), the heat sink (1120) according to another embodiment of the present invention is assembled.

The present invention has been described with reference to an embodiment illustrated in the accompanying drawings; however, this is merely exemplary. Those skilled in the art will understand that various modifications and equivalent alternative embodiments may be derived therefrom.

Accordingly, the true scope of protection of the present invention should be determined solely by the appended claims.

1. A battery pack comprising:
a battery module assembly;
a flow passage unit coupled to the battery module assembly and configured to allow a cooling fluid to flow therethrough;
a plurality of heat sinks, each having an accommodation portion, which is a space between partition walls formed on a side surface of the flow passage unit, wherein a heat-absorbing material is accommodated in the accommodation portion; and
pipes connecting the respective heat sinks,
wherein each of the heat sinks comprises:
a first plate having a groove-shaped flow passage unit formed on one surface thereof, the groove being open at an upper side, and having the accommodation portion formed on the other surface thereof, the groove being open at a lower side;
a second plate coupled to cover the one surface of the first plate; and
a third plate coupled to cover the other surface of the first plate,
wherein the heat sinks are coupled to a bottom surface of the battery module assembly,
wherein the flow passage unit comprises a linear flow passage unit extending in a straight direction and a curved flow passage unit configured to change a flow direction of the linear flow passage unit,
wherein the flow passage unit is configured such that the linear flow passage unit and the curved flow passage unit are symmetrically formed on both sides of the first plate based on a center thereof, and
wherein the third plate is coupled to the other surface of the first plate in correspondence with a region where the heat-absorbing material is accommodated.

2. The battery pack of claim 1,
wherein the partition walls have an inclined shape with respect to a bottom surface of the first plate or have a curved shape.

3. The battery pack of claim 1,
wherein an inlet hole through which the cooling fluid flows into and an outlet hole through which the cooling fluid is discharged are formed in the outermost linear flow passage unit of the first plate.

4. The battery pack of claim 3,
wherein the third plate has port holes formed at positions corresponding to the inlet hole and the outlet hole.

5. The battery pack of claim 3,
wherein the heat sink includes an inlet port connected to the inlet hole and an outlet port connected to the outlet hole.

6. The battery pack of claim 1,
wherein the third plate includes an injection port through which the heat-absorbing material is injected into the accommodation portion.

7. The battery pack of claim 6,
wherein the injection port is formed in a central region of the third plate.

8. The battery pack of claim 6,
wherein the battery pack includes a suction port configured to intake air from the accommodation portion.

9. The battery pack of claim 8,
wherein the suction port is formed in a corner region of the third plate.

10. The battery pack of claim 1,
wherein the heat-absorbing material is accommodated in the accommodation portion in a solid or liquid state and is formed to correspond to the shape of the side surfaces of the partition walls.

11. A battery pack comprising:
a battery module assembly;
a plurality of heat sinks disposed in correspondence with the battery module assembly;
wherein at least one of the heat sinks comprises:
a first plate having a groove shape formed on one surface thereof and a groove shape formed on the other surface thereof;
a second plate covering the one surface of the first plate;
a third plate covering the other surface of the first plate; and
a flow passage unit formed in the groove shape on the one surface of the first plate, the flow passage unit being configured to allow a cooling fluid to flow therethrough,
wherein an accommodation portion is disposed between sections of the flow passage unit, and a heat-absorbing material is accommodated in the accommodation portion,
wherein the flow passage units of the respective heat sinks are connected through pipes, and
wherein a protruding surface of the groove shape formed on the one surface of the first plate is lower than an end surface of the second plate.

12. The battery pack of claim 11,
wherein the at least one heat sink is coupled to a bottom surface of the battery module assembly.

13. The battery pack of claim 11,
wherein the flow passage unit comprises a linear flow passage unit formed in a longitudinal direction of the at least one heat sink and a curved flow passage unit configured to change a flow direction of the linear flow passage unit.

14. The battery pack of claim 13,
wherein the flow passage unit is configured such that the linear flow passage unit and the curved flow passage unit are symmetrically formed on both sides of the first plate based on a center thereof.

15. The battery pack of claim 11,
wherein partition walls are formed on side surfaces of the flow passage unit,
wherein the partition walls are formed between the groove shape formed on the one surface of the first plate and the groove shape formed on the other surface of the first plate, and
wherein the partition walls have an inclined shape with respect to a bottom surface of the first plate or have a curved shape.

16. The battery pack of claim 13,
wherein the linear flow passage unit comprises a first linear flow passage unit and a second linear flow passage unit,
wherein an inlet hole through which the cooling fluid is introduced is formed in the first linear flow passage unit, and
wherein an outlet hole through which the cooling fluid is discharged is formed in the second linear flow passage unit.

17. The battery pack of claim 16,
wherein the third plate has port holes formed at positions corresponding to the inlet hole and the outlet hole.

18. The battery pack of claim 11,
wherein the third plate includes a plurality of ports,
wherein the plurality of ports include an injection port and a suction port,
wherein the injection port is formed in a central region of the third plate, and
wherein the suction port is formed in a corner region of the third plate.

19. The battery pack of claim 15,
wherein the heat-absorbing material is formed to correspond to the shape of the side surfaces of the partition walls.

20. The battery pack of claim 11,
wherein a width of the flow passage unit is greater than a width of the accommodation portion.
